(19) United States
(12) Patent Application Publication
(10) Pub. No.: US 2026/0204185 A1
(43) Pub. Date: Jul. 16, 2026

(54) THIN VEHICLE LAMP ASSEMBLY PRESENTING ILLUMINATED HOMOGENOUS ELEMENT

(71) Applicant: Autosystems, a division of Magna Exteriors Inc, Aurora (CA)

(72) Inventors: Jeremy R. Sasena, Canton, MI (US); Justin F. Lumley, Westland, MI (US)

(21) Appl. No.: 19/441,376

(22) Filed: Jan. 6, 2026

Related U.S. Application Data
(60) Provisional application No. 63/744,546, filed on Jan. 13, 2025.

(51) Int. Cl. G09F 13/04; B60R 13/00; B60Q 1/50

(52) U.S. Cl. CPC G09F 13/0409; B60R 13/005; G09F 13/0404; G09F 13/044; B60Q 1/503

(57) ABSTRACT

A lamp assembly for a vehicle includes a housing, and a lens overlying the housing. The lens includes: a planar or non-planar portion with a generally planar shape, and a projecting portion that protrudes generally perpendicular to the planar portion to define a given shape. The projecting portion of the lens defines a pocket that is recessed therein. The lamp assembly also includes: a cover disposed within the pocket, and a printed circuit board (PCB). The PCB is disposed between the housing and the lens and has a plurality of light emitting diodes (LEDs) mounted thereto for illuminating the lens.

### CROSS REFERENCE TO RELATED APPLICATIONS

This utility patent application claims the benefit of U.S. Provisional Patent Application No. 63/744,546 filed January 13, 2025, the contents of which is incorporated herein by reference in its entirety.

### FIELD

The present disclosure relates generally to lighting for motor vehicles. More specifically, the present disclosure relates to a lamp assembly for a vehicle and which presents an illuminated outline of a shape, such as an alphanumeric character and/or a lamp and/or function.

### BACKGROUND

Lamp assemblies for motor vehicles often use light emitting diodes (LEDs) to efficiently provide either decorative or legally required illumination. These lamp assemblies rely upon the LEDs facing outward, toward a viewer, which can create hotspots that are visible to the viewer. Eliminating or reducing hotspots often requires the use of additional optical components such as inner lens, diffusers or textures which increases cost and decreases overall efficiency. In addition, the lamp typically requires significantly more package depth in order to provide adequate optical mixing length required to reduce the effect of hotspots. This results in an overall increase in volume and mass and overall system cost.

### SUMMARY

The present disclosure provides a lamp assembly for a vehicle. The lamp assembly includes a housing, and a lens overlying the housing. The lens includes: a planar portion with a generally planar shape, and a projecting portion that protrudes perpendicular to the planar portion to define a given shape. The projecting portion of the lens defines a pocket that is recessed therein.

The lamp assembly also includes: a cover of opaque material disposed within the pocket and fastened to the lens.

The present disclosure also provides a lamp assembly for a vehicle and which includes: a housing having a side edge and defining a reflective surface; a lens overlying the housing; and a cover of opaque material adjacent to the lens and defining a recessed portion facing toward the housing and containing a printed circuit board (PCB) and one or more LEDs.

These and other aspects of the present disclosure are disclosed in the following detailed description of the embodiments, the appended claims, and the accompanying figures.

### BRIEF DESCRIPTION OF THE DRAWINGS

Further details, features and advantages of designs of the invention result from the following description of embodiment examples in reference to the associated drawings.

FIG. 1 shows a front perspective view of a vehicle having a front bumper with an illuminated lamp assembly, in accordance with an aspect of the present disclosure;

FIGS. 2A-2B show front and rear views, respectively, of a lamp assembly for the illuminated lamp assembly, in accordance with an aspect of the present disclosure;

FIG. 3 shows a front view of the lamp assembly that is illuminated to present an illuminated outline of a given shape, in accordance with an aspect of the present disclosure;

FIGS. 4A-4B show front and rear exploded views, respectively, of the lamp assembly for the illuminated lamp assembly, in accordance with an aspect of the present disclosure;

FIG. 5 shows a cutaway top view of the lamp assembly of the illuminated lamp assembly, in accordance with an aspect of the present disclosure;

FIGS. 6A-6C show various views of a lens of the lamp assembly, in accordance with an aspect of the present disclosure;

FIGS. 7A-7C show various views of a housing of the lamp assembly, in accordance with an aspect of the present disclosure;

FIG. 8 shows another illuminated lamp assembly, in accordance with an aspect of the present disclosure;

FIG. 9 shows another illuminated lamp assembly, in accordance with an aspect of the present disclosure; and

FIG. 10 shows another illuminated lamp assembly, in accordance with an aspect of the present disclosure.

### DETAILED DESCRIPTION

Referring to the drawings, the present invention will be described in detail in view of following embodiments. Objectives of the present disclosure include providing a lamp assembly in a thin package space, which provides a uniform homogenous appearance, without any hot spots or dark spots. Further objectives of the present disclosure include providing such a lamp assembly with low cost, with a robust structure, and which meets requirements for exterior automotive lighting.

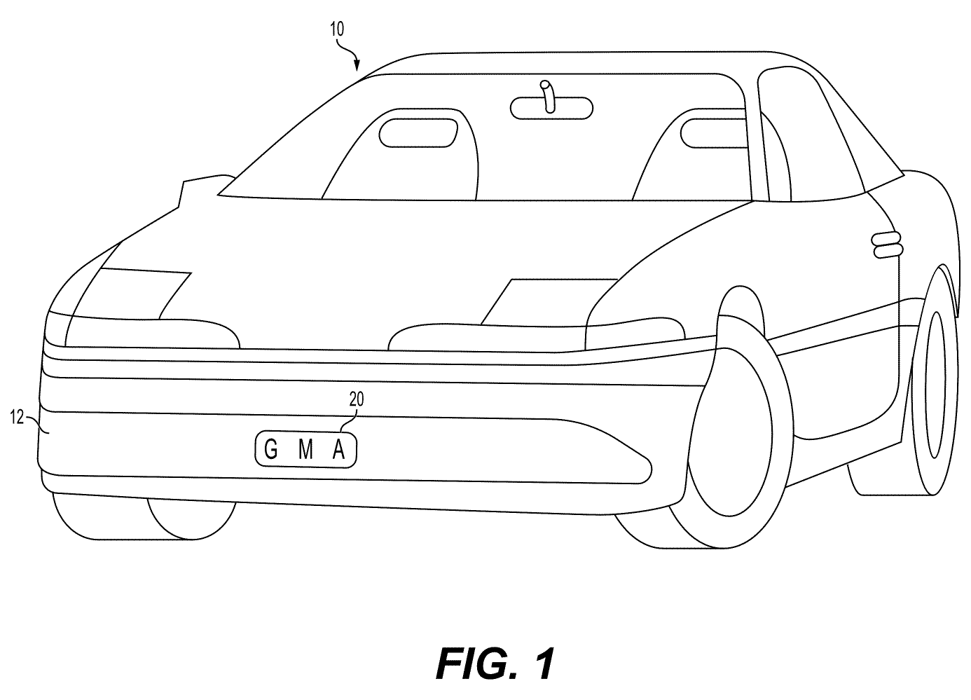

FIG. 1 shows a schematic block diagram of a vehicle 10 having a front bumper 12 with an illuminated lamp assembly 20, according to an aspect of the present disclosure. The vehicle 10 may be a motor vehicle, such as a passenger car or truck. However, the illuminated lamp assembly 20 of the present disclosure may be applicable to other types of vehicles, such as commercial trucks, busses, trains, etc. The vehicle 10 with the illuminated lamp assembly 20 of the present disclosure may also be referred to as the ego vehicle or the subject vehicle. The illuminated lamp assembly 20 may be mounted or otherwise located elsewhere on an exterior and/or an interior of the vehicle 10, such as on a hood, or on a rear surface. For example, the illuminated lamp assembly 20 may be mounted to a trunk, a liftgate, a tailgate, or a rear fascia. The illuminated element may also be constructed of various shapes and sizes to support regulated or decorative signal functions. For example, the element may represent the vehicle’s Tail or Parking Lamps, as well as others.

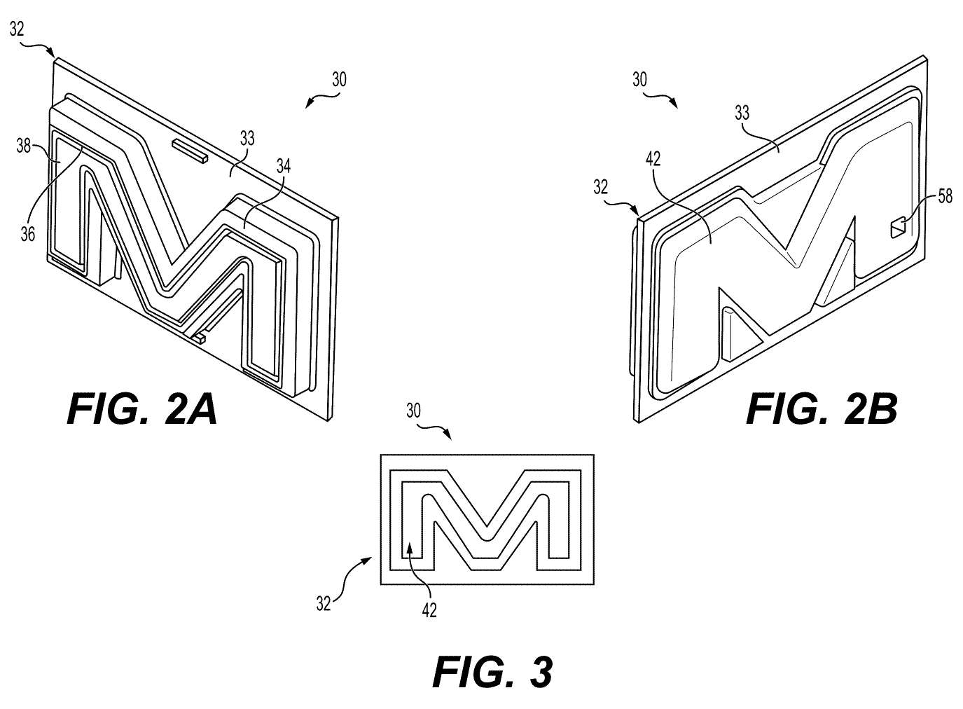

FIGS. 2A -2B show front and rear views, respectively, of a lamp assembly 30 for the illuminated lamp assembly 20. In some embodiments, and as shown in the drawings, the illuminated lamp assembly 20 includes a plurality of the lamp assemblies 30. However, the illuminated lamp assembly 20 may include only one of the lamp assemblies 30.

As shown in FIGS. 2A -2B , the lamp assembly 30 includes a lens 32 having a planar portion 33 with a generally planar shape and with a projecting portion 34 that protrudes perpendicular to the planar portion 33 to define a given shape. The lens 32 also includes a rear surface 37 that faces toward the housing 42. The lens 32 may be made of a translucent material. For example, the planar portion 33 of the lens 32 may be made of Poly(methyl methacrylate) (PMMA) that is diffusive to light or Polycarbonate (PC) that is diffusive to light by either diffusive material or via grain applied to the tool. Another material or Quantum Dots may be used. The given shape shown on FIGS. 2A -2B and FIG. 3 is a block letter “M”. However, the given shape may be any alphanumeric character or another shape, such as a lamp or other shape and function. The projecting portion 34 of the lens 32 defines a pocket 36 that is recessed relative to the projecting portion 34, but which is still proud of or in front of the planar portion 33. The lens 32 may have a total depth of about 23 millimeters.

The lamp assembly 30 also includes a cover 38 of opaque material that is disposed in the pocket 36. The cover 38 may be formed with the lens 32 via a 2-shot molding process. Alternatively, the cover 38 may be formed separately from the lens 32 and affixed thereto. For example, the cover 38 may be affixed to the lens 32 using a welding process.

The lamp assembly 30 also includes a housing 42 of opaque material disposed on a rear surface of the lens 32, opposite from the projecting portion 34. The housing 42 may be made of Polycarbonate (PC) that is opaque. However, the housing 42 may be made of a different material. The housing 42 shape defines a reflector optic to redirect light rays and illuminate the lens surface. Incident light rays from the source to the reflector are redirected into primary lens. FIG. 2B also shows the housing 42 defining a wiring aperture 58 for an electrical connection to a printed circuit board (PCB) 40 of the lamp assembly 30 (not shown on FIGS. 2A-2B).

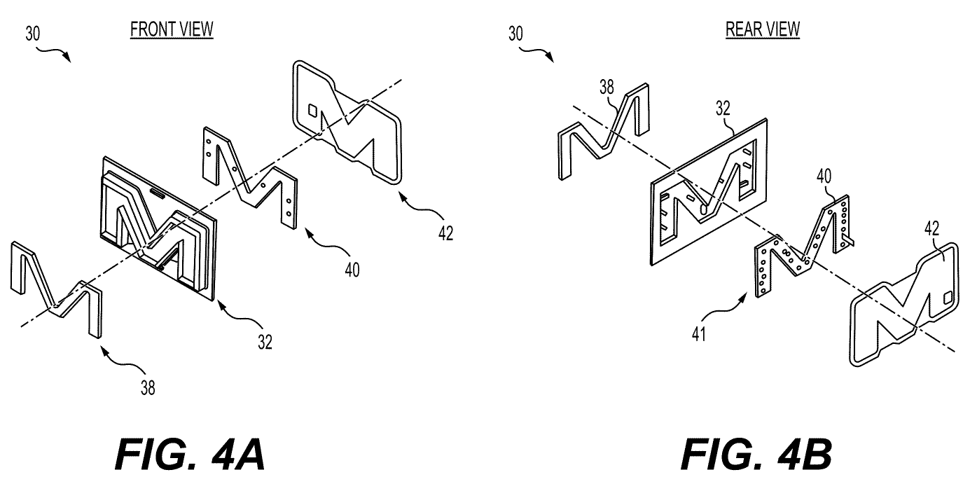

FIGS. 4A -4B show front and rear exploded views, respectively, of the lamp assembly 30 for the illuminated lamp assembly 20. As shown, the lamp assembly 30 includes the cover 38 overlying the lens 32. The lens 32 overlies a PCB 40. The housing 42 overlies the rear surface 37 of the lens 32, with the PCB 40 enclosed between the lens 32 and the housing 42. The PCB 40 may be made of white colored glass-reinforced epoxy laminate material, which may have a NEMA designation of FR4. However, the PCB 40 may have a different color and/or a different material. A plurality of light emitting diodes (LEDs) 41 are mounted on the PCB 40 and electrically connected thereto. In some embodiments, the LEDs 41 may be arranged in the given shape. In some embodiments, the LEDs 41 may be configured to partially, entirely, or primarily emit light from sides thereof, generally parallel to the planar portion 33 of the lens 32.

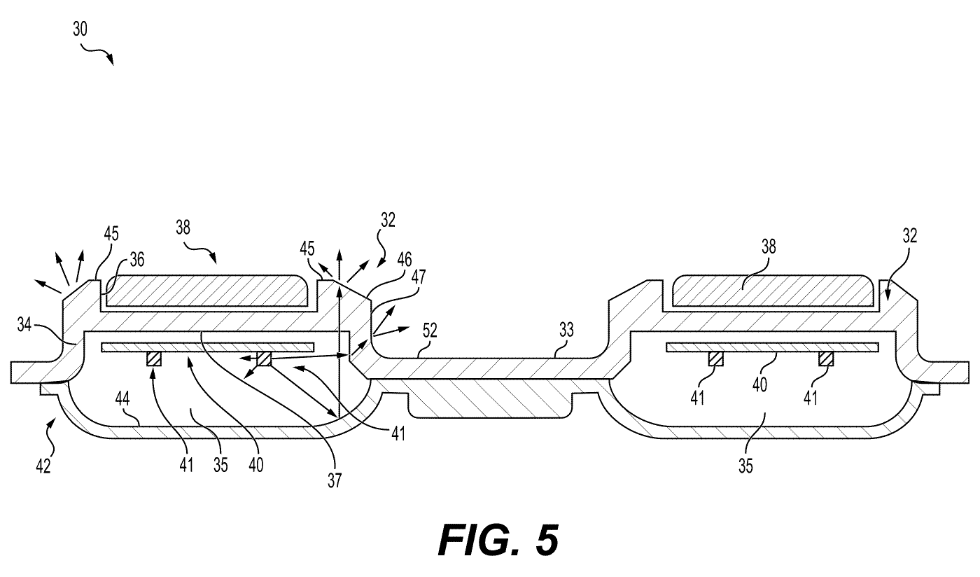

FIG. 5 shows a cutaway top view of the lamp assembly 30 of the illuminated lamp assembly 20. As shown, the projecting portion 34 protrudes perpendicular to the planar portion 33 and defines a top surface 45 that is generally parallel to and spaced apart from the planar portion 33. The projecting portion 34 also defines a beveled surface 46 that extends from the top surface 45 and is sloped back toward the planar portion 33. The top surface 45 and the beveled surface 46 together define an emission surface 45, 46 that is configured to emit light therefrom to define the outline of the given shape. The projecting portion 34 also includes a side surface 47 that extends between the planar portion 33 and the beveled surface 46 and which is generally perpendicular to the planar portion 33. Light may also be emitted from the side surfaces 47. For example, and as shown in FIG. 5, the LEDs 41 emit light from sides thereof and directly out of the side surfaces 47.

As shown, the housing 42 defines a reflective surface 44 facing toward the lens 32. Light from the LEDs 41 may be reflected off the reflective surface 44 and out of the emission surface 45, 46 of the lens 32. The lens 32 and the housing 42 define a chamber 35 therebetween and the PCB 40 is disposed within the chamber 35, adjacent to the rear surface 37 of the lens 32, and surrounded by the projecting portions 34. The lens 32, therefore, acts as an upper housing to partially define the chamber 35. Additionally, the planar portion 33 of the lens 32 defines a front surface 52 facing away from the housing 42. The planar portion 33 of the lens 32 also defines a first recess 54 opposite of the front surface 52.

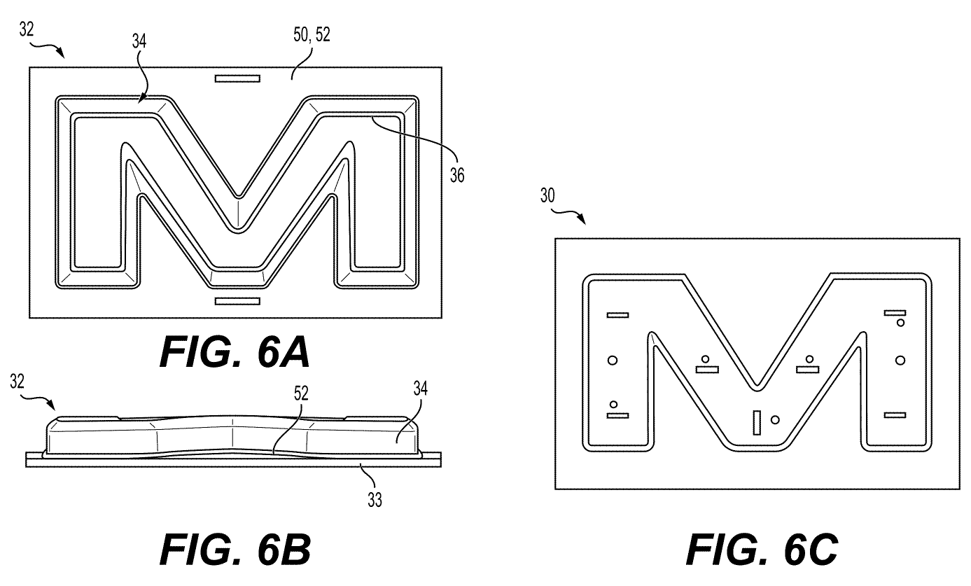

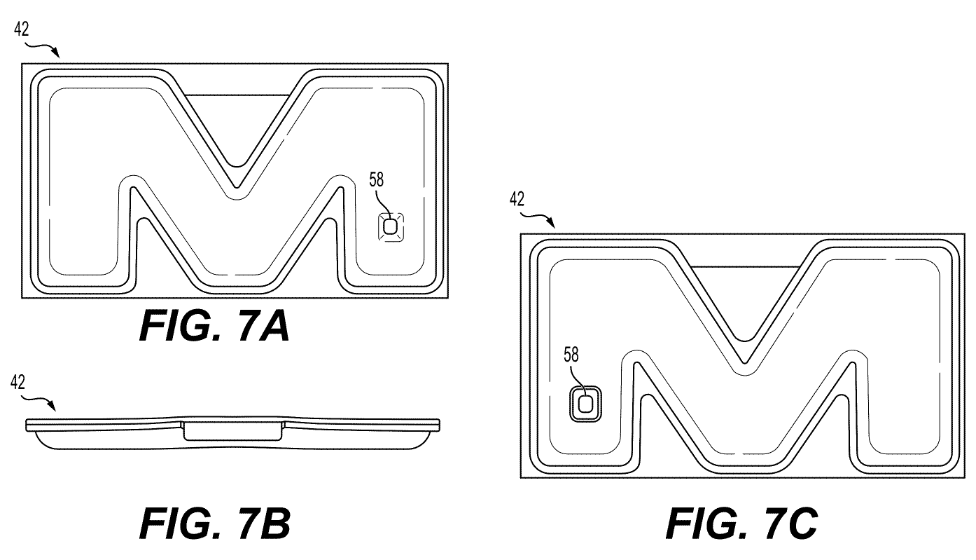

FIGS. 6A-6C show various views of the lens 32. FIGS. 7A-7C show various views of the housing 42. FIGS. 7A and 7C also show the wiring aperture 58 for accommodating an electrical connection to the PCB 40. In some embodiments, the wiring aperture 58 may function as a molded-in connector for receiving and retaining a wiring connection to the PCB 40. As shown on FIG. 2B, an electrical connector may protrude from the PCB 40 for receiving a wiring connection through the wiring aperture 58. Alternatively or additionally, one or more wires or other electrical conductors may extend through the wiring aperture 58 and be directly connected to the PCB 40.

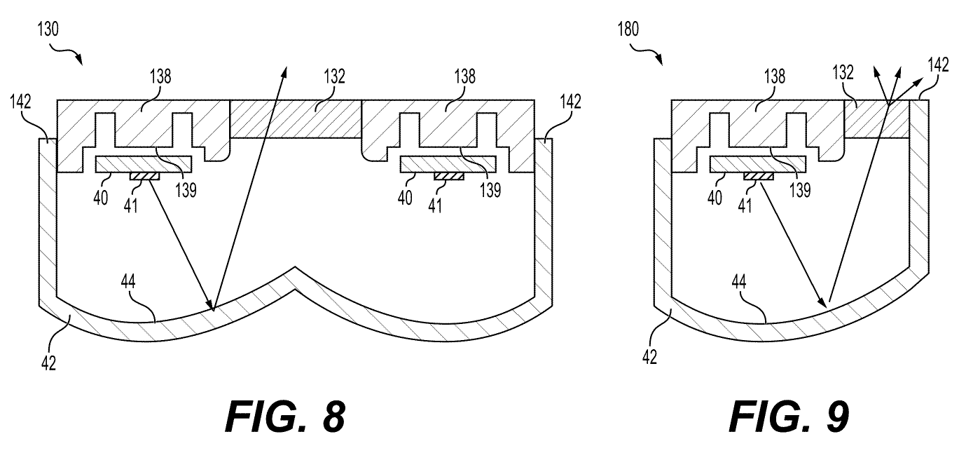

FIG. 8 shows a second illuminated lamp assembly 130 of the present disclosure. The second illuminated lamp assembly 130 includes a second lens 132 and two second covers 138. The second covers 138 may be made of an opaque material. Each of the two second covers 138 defines a first recessed portion 139 that faces toward the housing 42 and which contains a PCB 40 and one or more LEDs 41. The first recessed portion 139 may be configured so as at least some light from the one or more LEDs 41 at least partially exposed to the second lens 132, and thus able to directly illuminate the second lens 132. Each of the two second covers 138 is located between a corresponding side edge 142 of the housing 42 and the second lens 132. Thus, the second lens 132 extends between the two second covers 138. In some embodiments the second lens 132 may be made of a diffusive material. Alternatively, the second lens 132 may define a grain texture on an inner surface thereof for diffusing the light passing therethrough. Alternatively or additionally, and for example where there is a separate outer lens overlying the second lens 132, the grain texture may be defined on an outer surface of the second lens 132. The diffusive material and/or grain texture may be necessary to prevent the one or more LEDs 41 from being visible to an observer outside of the second illuminated lamp assembly 130.

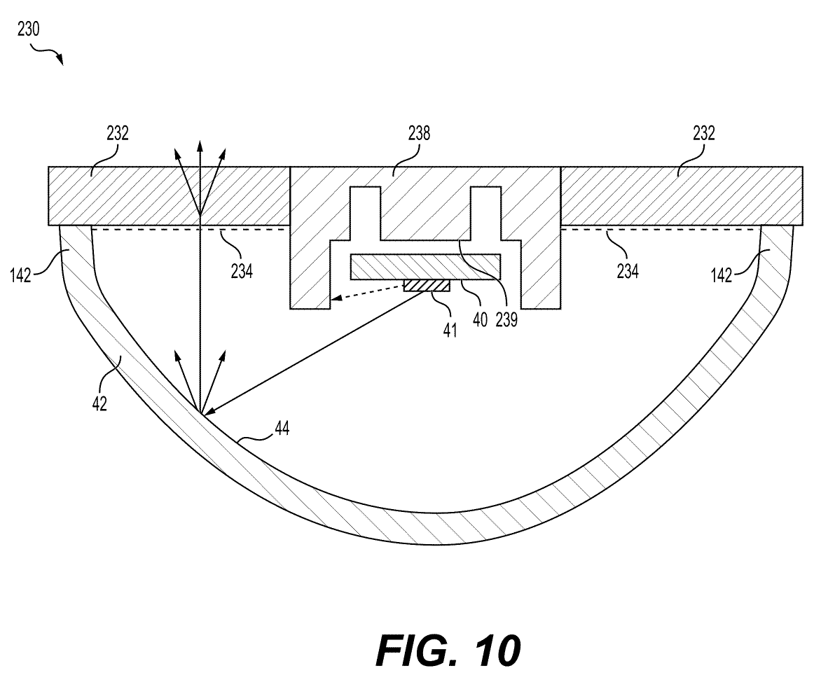

FIG. 9 shows a third illuminated lamp assembly 180 of the present disclosure. The third illuminated lamp assembly 180 may be similar or identical to the second illuminated lamp assembly 130, except the third illuminated lamp assembly 180 includes only one of the second covers 138, and which is located between a side edge 142 of the housing 42 and the second lens 132. FIG. 10 shows a fourth illuminated lamp assembly 230 of the present disclosure. The fourth illuminated lamp assembly 230 may be similar or identical to the third illuminated lamp assembly 180, except for a few differences described herein. The fourth illuminated lamp assembly 230 includes a cover 238 that defines a second recessed portion 239 which faces toward the housing 42. The cover 238 may be made of an opaque material. The cover 238 of the fourth illuminated lamp assembly 230 is spaced away from the side edges 142 of the housing 42. The fourth illuminated lamp assembly 230 includes a lens 232 that extends between the cover 238 and each of two opposite side edges 142 of the housing 42. In some embodiments, and as shown in FIG. 10, the lens 232 overlies each of the two opposite side edges 142 of the housing 42. The second recessed portion 239 contains a PCB 40 and one or more LEDs 41. The second recessed portion 239 may shield substantially all light from the one or more LEDs 41 therein from directly reaching the second lens 132. Thus, all light from the from the one or more LEDs 41 that reaches the second lens 132 must first reflect off the reflective surface 44 of the housing 42.

In FIG. 10, the lens 232 includes an inner surface 234 that faces toward the housing 42 and which defines a grain texture for diffusing light passing therethrough. Alternatively or additionally, and for example where there is a separate outer lens overlying the lens 232, the grain texture may be defined on an outer surface of the lens 232. The grain texture may be comparable to grit of sandpaper and may have a roughness that varies depending on a particular application. The grain texture may provide a diffusive effect with a non-diffuse material and which may have a lower cost than a lens with diffusive material characteristics.

In some embodiments, the product of the present disclosure consists of a housing, a lens, a printed circuit board (PCB) with LEDs, and a decorative Cover. The Cover may be fastened to the lens by either a 2-shot mold or welded. The PCB may be fastened to the back of the lens by either screws, heat stakes, or snaps. The lens sub-assembly may be welded to the housing. The housing may have a molded-in connector to allow for the external electrical connection. The lamp may light up as a signal function, logo, or other lighting application pending the operation on the vehicle per customer requirements.

Some important features may include: A thin lit element for exterior automotive lighting applications; a uniform, homogenous appearance; a lit area that may target the outlined boundary of the application, but could also be center or asymmetrically lit; and rearward facing LEDs (opposite from target direction).

The present disclosure provides a lamp assembly for a vehicle. The lamp assembly includes a housing, and a lens overlying the housing. The lens includes: a planar portion with a generally planar shape, and a projecting portion that protrudes perpendicular to the planar portion to define a given shape. The projecting portion of the lens defines a pocket that is recessed therein. The lamp assembly also includes: a cover disposed within the pocket; and a printed circuit board (PCB) that is disposed between the housing and the lens. The PCB has having a plurality of light emitting diodes (LEDs) mounted thereto for illuminating the lens.

In some embodiments, the lens includes a rear surface facing toward the housing, and wherein the lens and the housing together define a chamber therebetween, and wherein the PCB is disposed within the chamber, adjacent to the rear surface of the lens and surrounded by the projecting portions.

In some embodiments, the cover is affixed to the lens via a 2-shot molding process.

In some embodiments, the cover is affixed to the lens by welding.

In some embodiments, the housing defines a molded-in connector for an electrical connection to the PCB.

In some embodiments, the plurality of LEDs face rearward, opposite from a target direction for light to be directed.

In some embodiments, the lens includes a rear surface facing toward the housing, and wherein the PCB is fastened to the rear surface of the lens or cover using at least one of: screws, heat stakes, snaps, and or other methods.

In some embodiments, the lens and the cover, together present an illuminated appearance defining an outline of the given shape, with the cover defining a darkened interior of the given shape.

In some embodiments, the lamp assembly further includes a printed circuit board (PCB) disposed between the housing and the lens and having a plurality of light emitting diodes (LEDs) mounted to a surface thereof for illuminating the lens, and the plurality of LEDs are configured to emit light in a direction parallel to the surface of the PCB.

In some embodiments, the projecting portion defines a top surface that is generally parallel to and spaced apart from the planar portion, and wherein light is emitted from the top surface.

In some embodiments, the projecting portion further defines a beveled surface that extends from the top surface and is sloped back toward the planar portion, and wherein light is emitted from the beveled surface.

In some embodiments, the projecting portion defines a side surface that is generally perpendicular to the planar portion, and wherein light is emitted from the side surface.

In some embodiments, the housing defines a reflective surface facing toward the lens, and wherein the reflective surface is configured to reflect light from the LEDs and out of an emission surface of the lens.

The present disclosure also provides an illuminated lamp for a vehicle including one or more lamp assemblies as set forth herein.

In some embodiments, the one or more lamp assemblies include two or more of the lamp assemblies.

In some embodiments, the lamp structure and PCB support a non-planer or curved layout.

The present disclosure also provides a lamp assembly for a vehicle and which includes: a housing having a side edge and defining a reflective surface; a lens overlying the housing; and a cover of opaque material adjacent to the lens and defining a recessed portion facing toward the housing and containing a printed circuit board (PCB) and one or more LEDs.

In some embodiments, the cover of opaque material is spaced apart from the side edge to define an illuminated shape outline between the cover and the side edge of the housing.

In some embodiments, the cover of opaque material is adjacent to the side edge to define an illuminated shape spaced apart from the side edge of the housing.

In some embodiments, the one or more LEDs are at least partially exposed to the lens, and wherein the lens includes a diffusive material.

In some embodiments, the recessed portion of the cover is configured to shield substantially all light from the one or more LEDs from directly reaching the lens.

In some embodiments, the lens defines a grain texture on a surface thereof for diffusing light passing therethrough.

The foregoing description is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A lamp assembly for a vehicle, comprising:
a housing;
a lens overlying the housing, the lens including: a planar portion with a generally planar shape, and a projecting portion that protrudes perpendicular to the planar portion to define a given shape, wherein the projecting portion of the lens defines a pocket that is recessed therein; and
a cover of opaque material disposed within the pocket and fastened to the lens.

2. The lamp assembly of claim 1, further comprising a printed circuit board (PCB) disposed between the housing and the lens and having a plurality of light emitting diodes (LEDs) mounted thereto for illuminating the lens, and
wherein the lens includes a rear surface facing toward the housing, and wherein the lens and the housing together define a chamber therebetween, and wherein the PCB is disposed within the chamber, adjacent to the rear surface of the lens and surrounded by the projecting portions.

3. The lamp assembly of claim 1, wherein the cover is affixed to the lens via a 2-shot molding process.

4. The lamp assembly of claim 1, wherein the cover is affixed to the lens by welding.

5. The lamp assembly of claim 1, further comprising a printed circuit board (PCB) disposed between the housing and the lens and having a plurality of light emitting diodes (LEDs) mounted thereto for illuminating the lens, and
wherein the housing defines a molded-in connector for an electrical connection to the PCB.

6. The lamp assembly of claim 1, further comprising a printed circuit board (PCB) disposed between the housing and the lens and having a plurality of light emitting diodes (LEDs) mounted thereto for illuminating the lens, and
wherein the plurality of LEDs face rearward, opposite from a target direction for light to be directed.

7. The lamp assembly of claim 1, further comprising a printed circuit board (PCB) disposed between the housing and the lens and having a plurality of light emitting diodes (LEDs) mounted thereto for illuminating the lens, and
wherein the lens includes a rear surface facing toward the housing, and wherein the PCB is fastened to the rear surface of the lens using at least one of: screws, heat stakes, and/or snaps.

8. The lamp assembly of claim 1, wherein the lens and the cover, together present an illuminated appearance defining an outline of the given shape, with the cover defining a darkened interior of the given shape.

9. The lamp assembly of claim 1, further comprising a printed circuit board (PCB) disposed between the housing and the lens and having a plurality of light emitting diodes (LEDs) mounted to a surface thereof for illuminating the lens, and
wherein the plurality of LEDs are configured to emit light in a direction parallel to the surface of the PCB.

10. The lamp assembly of claim 1, wherein the projecting portion defines a top surface that is generally parallel to and spaced apart from the planar portion, and wherein light is emitted from the top surface.

11. The lamp assembly of claim 10, wherein the projecting portion further defines a beveled surface that extends from the top surface and is sloped back toward the planar portion, and wherein light is emitted from the beveled surface.

12. The lamp assembly of claim 1, wherein the projecting portion defines a side surface that is generally perpendicular to the planar portion, and wherein light is emitted from the side surface.

13. The lamp assembly of claim 1, further comprising a printed circuit board (PCB) disposed between the housing and the lens and having a plurality of light emitting diodes (LEDs) mounted thereto for illuminating the lens, and
wherein the housing defines a reflective surface facing toward the lens, and wherein the reflective surface is configured to reflect light from the plurality of LEDs and out of an emission surface of the lens.

14. An illuminated lamp for a vehicle including one or more lamp assemblies as set forth in claim 1.

15. The illuminated lamp of claim 14, wherein the one or more lamp assemblies include two or more of the lamp assemblies.

16. The lamp assembly of claim 1, further comprising a printed circuit board (PCB) disposed between the housing and the lens and having a plurality of light emitting diodes (LEDs) mounted thereto for illuminating the lens, and
wherein the housing defines a reflective surface facing toward the lens, and wherein the reflective surface is configured to reflect light from the plurality of LEDs and out of an emission surface of the lens as an internal sub-assembly to another lamp.

17. The lamp assembly of claim 1, wherein the lens is configured to diffuse light passing therethrough.

18. A lamp assembly for a vehicle, comprising:
a housing having a side edge and defining a reflective surface;
a lens overlying the housing; and
a cover of opaque material adjacent to the lens and defining a recessed portion facing toward the housing and containing a printed circuit board (PCB) and one or more LEDs.

19. The lamp assembly of claim 18, wherein the cover of opaque material is spaced apart from the side edge to define an illuminated shape outline between the cover and the side edge of the housing.

20. The lamp assembly of claim 18, wherein the cover of opaque material is adjacent to the side edge to define an illuminated shape spaced apart from the side edge of the housing.

21. The lamp assembly of claim 18, wherein the one or more LEDs are at least partially exposed to the lens, and wherein the lens includes a diffusive material.

22. The lamp assembly of claim 18, wherein the recessed portion of the cover is configured to shield substantially all light from the one or more LEDs from directly reaching the lens.

23. The lamp assembly of claim 18, wherein the lens defines a grain texture on a surface thereof for diffusing light passing therethrough.
